(19) United States
(12) Patent Application Publication
(10) Pub. No.: US 2013/0288506 A1
(43) Pub. Date: Oct. 31, 2013

(54) CONNECTION SYSTEM AND ACCOMMODATION UNIT FOR A CONTROL UNIT

(71) Applicants: Frank Straub, Leonberg (DE); Eugen Joos, Zaberfeld (DE); Marcus Kneifel, Valinhos/SP (BR); Juergen Stein, IIIingen (DE); Stephan Luetzerath, Ludwigsburg (DE)

(72) Inventors: Frank Straub, Leonberg (DE); Eugen Joos, Zaberfeld (DE); Marcus Kneifel, Valinhos/SP (BR); Juergen Stein, IIIingen (DE); Stephan Luetzerath, Ludwigsburg (DE)

(21) Appl. No.: 13/820,657

(22) PCT Filed: Jul. 19, 2011
(86) PCT No.: PCT/EP2011/062343

§ 371 Date: Jul. 17, 2013

(30) Foreign Application Priority Data
Sep. 10, 2010 (DE) 10 2010 040 595.7

(51) Int. Cl. B60R 16/023; H01R 13/62

(52) U.S. Cl. CPC B60R 16/023; H01R 13/62
USPC 439/345

(57) ABSTRACT

A connecting device for connecting a control unit in a motor vehicle includes: the control unit for implementing an electronic function, having a connector unit; an accommodation unit having a connector area for accommodating the corresponding connector unit of the control unit, and an accommodation area for accommodating the control unit either entirely or partially in the inserted state, the accommodation unit being connected to an electrical power supply cable and having a fastening device for fastening the accommodation unit.

### FIELD OF THE INVENTION

1. Field Of The Invention

The present invention relates to connecting devices for electrically and mechanically connecting a control unit to a cable harness, in particular in a motor vehicle.

2. Description Of The Related Art

Currently it is customary, when assembling motor vehicles, to first fasten control units for operating different devices in the interior of the motor vehicle and then to install plug connectors for connecting, via a cable harness, the control unit to units to be controlled. Therefore, when the electrical systems are assembled, handling the cable harness is complicated and, due to the weight and branching of the cable harness, forces act on the plug connection to the control unit, which may negatively affect the quality and reliability of the electrical contacting.

### BRIEF SUMMARY OF THE INVENTION

Therefore, an object of the present invention is to provide a connection system for establishing a connection between a cable harness and a control unit, which makes simple assembly possible and ensures enhanced reliability.

According to one first aspect, a connecting device is provided for connecting a control unit in a motor vehicle. The connecting device includes a control unit for implementing an electronic function, having a connector unit and an accommodation unit having a connector area for accommodating the matching connector unit of the control unit and having an accommodation area for accommodating the control unit entirely or partially in the inserted state, the accommodation unit being connected to an electrical supply cable and having a fastening device for fastening the accommodation unit.

One idea of the above-mentioned connecting device is to provide the electrical supply cable for connecting to a control unit having an accommodation unit, which includes a fastening device for installation on a part of the vehicle body or on a part directly connected to the vehicle body. The control unit is designed in such a way that, after the accommodation unit has been fastened, it may be inserted into the accommodation unit in such a way that its connector unit and the connector area of the accommodation unit establish an electrical connection with each other.

Therefore, for the assembly, first the connector unit, connected to the supply cables, is fastened to the vehicle body or to the part connected thereto using its fastening device, and the control unit is plugged into the connector unit in a further assembly step. This has the advantage that the assembly is made easier, since the cable harness is normally much larger and heavier than the control unit and therefore plugging a connector unit connected thereto into a fixed control unit is much more complicated than plugging a comparatively smaller and lighter control unit into a fixed connector unit.

Furthermore, the connector area may be designed as a contact slot, and/or the connector unit may be designed as a contact strip.

According to one specific embodiment, the fastening device may include a threaded hole.

It may be provided that the accommodation area includes a housing, which has an accommodating opening for accommodating the control unit.

The accommodation unit may be provided with a locking unit, which sticks out from the accommodation unit, the control unit having matching structures, so that when the control unit is inserted into the accommodation unit, the locking unit engages with the matching structures and thus holds the control unit reliably in the accommodation unit.

According to another aspect, an accommodation unit is provided with a connector area for accommodating a control unit having a matching connector unit, and with an accommodation area for entirely or partially accommodating the control unit, the accommodation unit being connected to an electrical supply cable, in particular a cable harness, and having a fastening device for fastening the accommodation unit.

According to another aspect, a method is provided for assembling a system having a control unit, which has a connector unit, for implementing an electronic function and having a unit, which is to be controlled by the control unit, connected via an electrical supply cable, having the following steps:
fastening an accommodation unit with the aid of a fastening device, the accommodation unit having a connector area for accommodating the matching connector unit of the control unit, and an accommodation area for accommodating the control unit entirely or partially in the inserted state, the accommodation unit being connected to an electrical supply cable,
connecting the control unit by placing the control unit into the accommodation area of the accommodation unit, so that the connector unit contacts the electrical supply cable via the connector area.

### BRIEF DESCRIPTION OF THE DRAWINGS

FIG. 1 shows a schematic illustration of a connection system for connecting a control unit to a cable harness.

FIG. 2 shows a perspective illustration of a possible embodiment variant of the connection system of FIG. 1.

### DETAILED DESCRIPTION OF THE INVENTION

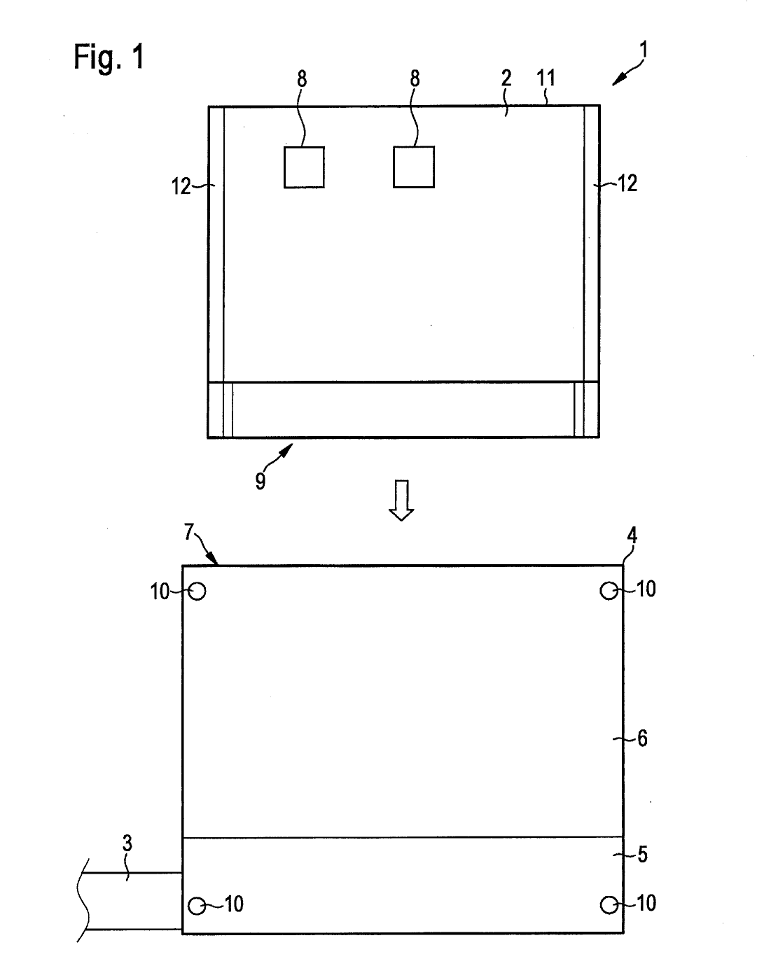

FIG. 1 shows a schematic illustration of a connection system 1 for connecting a control unit 2 to a cable harness 3, of which only an end piece ending in an accommodation unit 4 is shown.

For assembling electrical systems in a motor vehicle, it is necessary to connect control units, which are designed to control different units in a motor vehicle, via an electrical connection. The electrical connection takes place via cable harness 3, which includes a plurality of electrical conductors, which, depending on the distribution of the units to be controlled, usually divide into multiple branches.

Accommodation unit 4 is provided at one end of cable harness 3, to be connected to control unit 2. Accommodation unit 4 has a connector area 5 and an accommodation area 6. Connector area 5 is used to accommodate a contact strip and for this purpose is provided in its interior with a plurality of contact tongues (not shown), which are each connected or connectable to one or more conductors in cable harness 3.

Accommodation area 6 is essentially designed as a partially closed housing and has, at one end opposite to connector area 5, an accommodating opening 7, through which control unit 2 may be pushed in or inserted. The length of accommodation area 6 between connector area 5 and accommodating opening 7 may be selected in such a way that it accommodates control unit 2 entirely or only partially after it is inserted into accommodation unit 4.

Control unit 2 has a housing 11, in which electronic components 8 are accommodated, in particular on a printed circuit board. Electronic components 8 of control unit 2 are used to carry out a desired electronic function. Control units of this type often include microcontrollers and power components for supplying power via cable harness 3 according to a predetermined function to a unit to be controlled.

Electronic components 8 are connected to a connector unit in the form of a contact strip 9, which has individual contact surfaces (not shown). Contact strip 9 is designed in such a way that it may be plugged into the contact slot of connector area 5 and the contact surfaces may be contacted there, by the individual contact tongues.

Accommodation unit 4 is provided with fastening devices 10, using which accommodation unit 4 may be fastened to the vehicle body or a part connected to the vehicle body. The connection may be implemented by a threaded connection, an adhesive connection, or the like.

Housing 11 may have guide strips 12, which make guided insertion into accommodation unit 4 possible. For this purpose, accommodation unit 4 may have matching guide slots (not shown). The guide guides control unit 2 during the insertion so that contact strip 9 may be pushed into the contact slot of connector area 5.

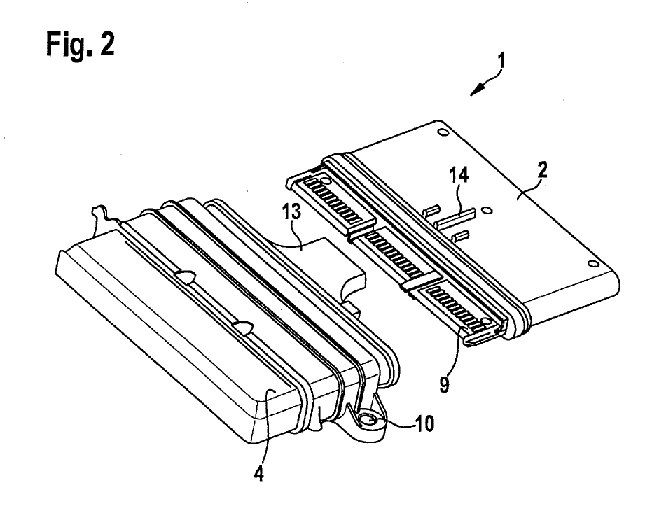

FIG. 2 shows a perspective illustration of a connection system 1 between a cable harness 3 and a control unit 2.

Accommodation unit 4 is provided with a locking unit 13, which sticks out from accommodation unit 4 in the direction of accommodation opening 7. Matching structures 14 are located on housing 11 of control unit 2, so that when control unit 2 is inserted into accommodation unit 4, locking unit 13 engages with matching structures 14 and thus holds control unit 2 reliably in accommodation unit 4. Locking unit 13 makes it possible to hold control unit 2 reliably on accommodation unit 4, so that the connection between cable harness 3 and control unit 2 is stable, ensuring a long service life of the electrical contacts.

Instead of pushing in control unit 2 into accommodation unit 4, accommodation unit 4 may also be designed in such a way that control unit 2 may be inserted into it from above, for example. For this purpose, it is not necessary for contact strip 9 to be situated on a narrow end of control unit 2, but it may be situated essentially at any point, so that when control unit 2 is inserted into accommodation unit 4, contact strip 9 is pushed into the contact slot accordingly provided in accommodation unit 4.

Control unit 2 may be supplied with a ground potential directly via accommodation unit 4, rather than via supply cables of cable harness 3. In this case, accommodation unit 4 may be designed at least partially electrically conductively, so that when it is fastened to the vehicle body or the like, an electrical connection with ground potential is automatically established. After being inserted into accommodation unit 4, control unit 2 may be connected to ground potential via housing 11, which also may be designed at least partially electrically conductively.

1-7. (canceled)

8. A connecting device for connecting a control unit in a motor vehicle, comprising:
the control unit for implementing an electronic function, the control unit having a connector unit; and
an accommodation unit having (i) a connector area for accommodating the connector unit of the control unit and (ii) an accommodation area for accommodating the control unit at least partially in the inserted state, wherein the accommodation unit is connected to an electrical supply cable and has a fastening device for fastening the accommodation unit.

9. The connecting device as recited in claim 8, wherein at least one of (i) the connector area is configured as a contact slot, and (ii) the connector unit is configured as a contact strip.

10. The connecting device as recited in claim 9, wherein the fastening device includes a threaded hole.

11. The connecting device as recited in claim 9, wherein the accommodation area includes a housing having an accommodating opening for accommodating the control unit.

12. The connecting device as recited in claim 9, wherein the accommodation unit has a locking unit configured as a protruding structure, and wherein the control unit has corresponding structures for engaging the protruding structure such that, when the control unit is inserted into the accommodation unit, the locking unit engages with the corresponding structures of the control unit to hold the control unit in the accommodation unit.

13. An accommodation unit, comprising:
a connector area for accommodating a control unit having a matching connector unit; and
an accommodation area for at least partially accommodating the control unit;
wherein the accommodation unit is connected to an electrical supply cable, and has a fastening device for fastening the accommodation unit.

14. A method for assembling a system having (i) a control unit including a connector unit, wherein the control unit implements an electronic function, and (ii) a further unit controlled by the control unit, wherein the further unit is connected via an electrical supply cable, the method comprising:
fastening an accommodation unit with the aid of a fastening device, the accommodation unit having a connector area for accommodating the connector unit of the control unit, and the accommodation unit further having an accommodation area for accommodating the control unit at least partially in the inserted state, and the accommodation unit being connected to the electrical supply cable; and
connecting the control unit by inserting the control unit into the accommodation area of the accommodation unit, whereby the connector unit contacts the electrical supply cable via the connector area.
